(19) United States
(12) Patent Application Publication
(10) Pub. No.: US 2023/0054497 A1
(43) Pub. Date: Feb. 23, 2023

(54) PARAFFIN WARMER

(71) Applicant: LTE PROPERTIES GROUP LLC, Elk Grove, CA (US)

(72) Inventors: Ezra Chan, Foster City, CA (US); Tri Nguyen, Sacramento, CA (US)

(21) Appl. No.: 17/404,436

(22) Filed: Aug. 17, 2021

(51) Int. Cl. A61H 33/04; A45D 44/00

(52) U.S. Cl. CPC A61H 33/04; A45D 44/00; A61H 2033/047

(57) ABSTRACT

A paraffin warmer is disclosed herein, which allows paraffin to be easily heated to a melting temperature within a tub and transferred to a container via a heated spigot. A spigot has a liquid channel that allows liquid paraffin to flow from a cavity of the tub out the spigot into the container that may be at room temperature. The tub of the paraffin warmer and a liquid channel through the spigot may be heated with first and second heating elements to prevent liquid paraffin from solidifying in the liquid channel of the spigot that would clog the spigot. The first heating element may be wrapped around the spigot to heat the liquid channel from where the paraffin exits the tub to the distal end of the spigot.

### CROSS-REFERENCE TO RELATED APPLICATIONS

Not Applicable.

### STATEMENT RE: FEDERALLY SPONSORED RESEARCH/DEVELOPMENT

Not Applicable.

### BACKGROUND

Paraffin wax is a useful material to treat skin in salons. Unfortunately, the current methods and apparatuses for use of paraffin in the salon context is inconvenient.

Thus, there is a need to improve current methods and apparatuses for dispensing liquid paraffin for use in the salon setting.

### BRIEF SUMMARY

Paraffin warmer systems and methods are disclosed herein. A paraffin warmer may have a tub having one or more cavities that holds paraffin and a spigot for each cavity that delivers paraffin from the respective cavity in the tub to a container, such as a bag or a cup. A heating element may be wrapped around the spigot to melt any paraffin within and/or about the spigot. This allows for melted liquid paraffin to be dispensed shortly after the heating element is activated—for example within 5, 10, 15, or 20 minutes of the heating element being activated. The heating element may be disposed on the spigot to heat an entire length of a liquid channel of the spigot from where the spigot exits the tub to the spout at the distal end of the spigot. By heating the entire liquid channel of the spigot, the heating element may liquefy solidified paraffin within the liquid channel along the entire length of the liquid channel when first starting up the paraffin warmer system or to keep the paraffin along the entire length of the liquid channel liquified while the paraffin warmer system is on. One or more separate heating elements may also be used to heat one or more cavities of the tub, where each heating element is configured to heat paraffin within the cavity, such as a coil, thick film heater, heater pad, and/or heater rod embedded within a floor of a tub cavity. Any other suitable device that may be used to heat paraffin within a cavity, as explained in further detail below.

Either heating element may be configured to heat a portion of the paraffin warmer (e.g., a cavity of the tub or a portion of the liquid channel of the spigot) to any suitable temperature that melts paraffin (i.e., a paraffin melting point), for example at least 120° F., 150° F., 200° F., 250° F., 300° F., or even 350° F. The heating element may be configured to sequentially heat to different temperatures. For example, the heating element may be configured to heat to a first temperature above the melting temperature of the paraffin for a first period of time (i.e., an initial fast melt temperature), and then to a second temperature above the melting temperature for a second period of time (i.e., a keep warm temperature). The keep warm temperature may be lower than the initial fast melt temperature, for example, the initial fast melt temperature may be 20° F. to 50° F. greater than the keep warm temperature. The spigot of the tub may comprise a material that does not melt or otherwise deform or bend when subjected to temperatures reached by the heating element, such as a polyamide nylon plastic that is not affected when exposed to temperatures below 392° F. A heating system which may include the heating element may be configured so that the heating element does not exceed temperatures above a melting point of the spigot material. For example, the heating element may be configured to reach a temperature above 300° F. but to not exceed 350° F.

The heating element may comprise any material suitable to produce heat. For example, the heating element may comprise a heat conducting metal or a silicone sheathed heating wire that may be wrapped around the spigot to heat portions of the spigot, such as the liquid channel within the spigot that liquid paraffin flows through. The heating element may be affixed to the spigot using any suitable means. For example, the heating element may be wrapped around the spigot using a stiff, bendable wire that remains in place about the spigot after twisting around a portion of the spigot. The heating element may also be affixed in place using an adhesive that is resistant to melting at high temperatures, such as a hardened glue or an aluminum tape. Such adhesives may be made of a material that is resistant to melting at temperatures of at least 400° F. or 600° F. The adhesive material may also be used to conduct heat from the heating element to the spigot that the heating element is affixed to. The adhesive material may have a high thermal conductivity (e.g., aluminum). Such adhesive materials may be used to reach areas of the spigot or the paraffin warmer where it is difficult for the heating element to be wrapped around the spigot or contact the paraffin warmer to facilitate conduction of heat from the heating element to the spigot and/or tub.

The heating element may be controlled by a temperature control board configured to heat the heating element to one or more predetermined temperatures. For example, the temperature control board may be configured to heat a heating element to at least the melting point of paraffin or to a fast-melt temperature well above the melting point of paraffin. The temperature control board may be configured to heat the heating element to an initial fast melt temperature, and then to the lower warm temperature when a portion of the tub reaches a threshold temperature, for example the melting point of paraffin after a set period of time (e.g., 15 minutes). A sensor may be used as a feedback mechanism to ensure that a target temperature of a material is reached and maintained. Such a sensor may be used to measure the temperature of any suitable material, such as a wall of the tub or a temperature of wax disposed within the tub. Alternatively, the temperature control board may be configured to heat the heating element to the initial fast melt temperature (e.g., 250° F.) for a first period of time (e.g., 15 min), and then thereafter to heat the heating element to the keep warm temperature (e.g., 120° F.) for a second period of time (e.g., until the paraffin warmer is turned off). The temperature control board may be configured to control multiple heating elements, such as a first heating element for a spigot and a second heating element for a cavity of the tub. The temperature control board may be configured to heat each of the first and second heating elements to a different temperature. For example, the temperature control board may be configured to heat the first and second heating element for the spigot and the tub to 250° F. then after to drop the temperature of the spigot to a lower temperature first before dropping the temperature of the tub. Such temperature control boards may be configured to activate one or more heating elements when the paraffin warmer is turned on, for example when a user activates a switch or plugs the unit into a power supply. Conversely, the temperature control board may also be configured to deactivate one or more heating elements when a sensor detects that the amount of paraffin within a tub has decreased to below a threshold level.

A thermal insulator may be used to protect a user from getting burned by the spigot or the heating element. For example, an insulating cover made of a plastic thermal insulating material may be used to encapsulate a portion of the heating element or spigot to prevent a user from getting burned while they retrieve hot liquid paraffin from the spigot. The thermal insulator may comprise any material having a high R-value, such as a polyurethane or a polyethylene. The polyurethane and/or polyethylene may be encapsulated into a housing made from hard plastic (e.g., polypropylene).

A user of such a paraffin warmer system may use the system to dispense liquid paraffin by first disposing a volume of paraffin into a tub, for example by opening a top of the tub and by pouring liquid paraffin into the tub, by pouring solid paraffin pellets into the tub, or by placing bars of paraffin within one or more cavities of the tub. Such tubs may be sized in any suitable manner, for example such tubs may be sized to be an upright, cylindrical shape similar to a tabletop hot water maker. The paraffin warmer system may melt any paraffin in the tub and such melted or liquified paraffin may be dispensed through the spigot for use on a customer of a salon. At night or when needed, the paraffin warmer system may be turned off. At this time, the liquid paraffin may solidify as it cools. Later when a customer requests a paraffin wax treatment, a user may turn the paraffin warmer system on. The paraffin warmer system may quickly melt the wax in the tub. Because of its separate heater element in the spigot, the paraffin is quickly melted for dispensation (e.g., less than 15 minutes) so that the melted paraffin can be dispensed quickly, and a customer may be treated with the paraffin. Optionally, the paraffin warmer system may melt the solidified wax in the spigot and tub by controlling the temperatures of a first and second heating elements by temperature and time. During use, the user may, for example, activate a switch functionally coupled to a temperature control board configured to heat a heating element about the spigot to at least a paraffin melting point. After the wax has melted in the tub and spigot, the user may then place a container below a spout of the spigot and open a valve of the spigot to allow melted paraffin to travel through the heated liquid channel of the spigot out of the spout of the spigot and into the container. Initially, the user may need wait first before opening the valve when the paraffin warmer system is first turned on, for example for at least 5, 10, 15, or 20 minutes, to allow any solid paraffin in the tub and in the spigot to melt. The user may leave the paraffin warmer system on during the normal hours of operation of the business or may turn the paraffin warmer system on only when a customer requests a paraffin treatment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a side perspective view of paraffin warmer system having paraffin solidified in a spout of a spigot extending from a tub.

FIG. 2 shows another side perspective view of the paraffin warmer system of FIG. 1, having a valve of the spigot opened to allow liquid paraffin to flow from the tub into a container.

FIG. 3 shows a top perspective view of a portion of the spigot of FIG. 1, separated into a bottom part and a top part.

FIG. 4 shows a cross-sectional view of the paraffin warmer system of FIG. 1.

FIG. 5 shows a side perspective view of the spigot of FIG. 1, having a heating element affixed to the spigot extending from the tub.

FIG. 6 shows a side perspective view of an alternative paraffin warmer tub, having a heating element affixed to the spigot extending from the tub.

FIG. 7 shows a side perspective view of an alternative paraffin warmer tub, having a heating element affixed to the spigot extending from the tub.

FIG. 8 shows a front perspective view of the paraffin warmer tub of FIG. 7.

FIG. 9 shows a cross-sectional view of the paraffin warmer tub of FIG. 7, having an insulating cover partially disposed about the spigot to shield heat from the heating element from reaching the exterior surface of the insulating cover.

FIG. 10 shows a front perspective view of the paraffin warmer tub of FIG. 9, wherein the insulating cover is fully disposed about the spigot.

FIG. 11 is a schematic of an exemplary paraffin warmer system.

### DETAILED DESCRIPTION

The following detailed description describes a novel paraffin warmer and method.

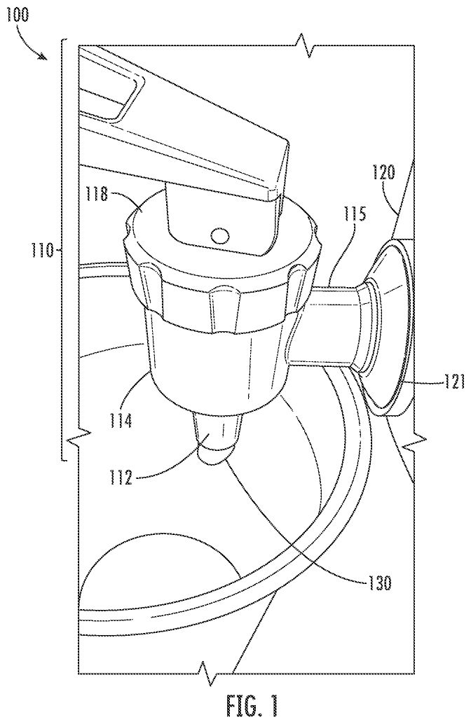

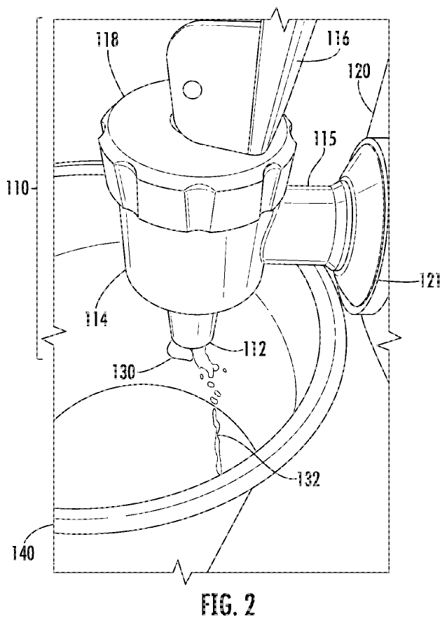

A paraffin warmer system 100, shown in FIGS. 1, 2, 3, and 4, may have a tub 120 configured to heat paraffin to a liquid state and may have a spigot 110 extending from the tub that may be used to dispense the liquid paraffin 132 (shown in FIG. 2) from the tub 120 into the container 140. When a lever 116 of the spigot 110 is moved from the closed position shown in FIG. 1 to the open position shown in FIG. 2, liquid paraffin 132 may flow from the tub 120, through the pipe 115, out the spout 112, and finally into the container 140. However, when the lever 116 is then moved back to the closed position shown in FIG. 1, the liquid paraffin 132 stops flowing into the container 140.

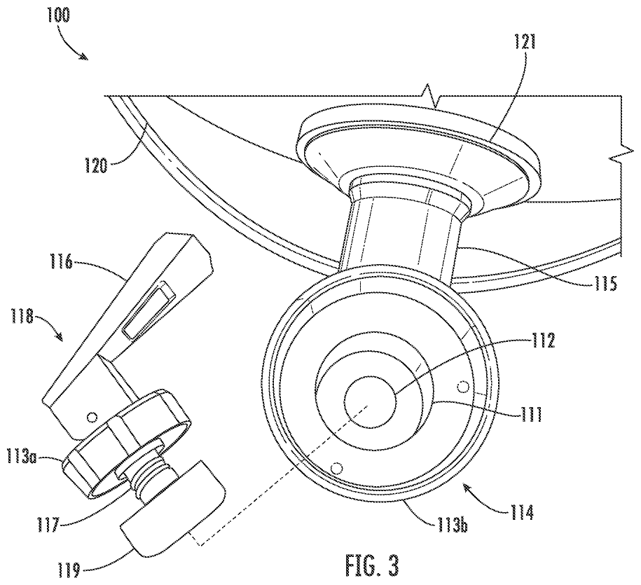

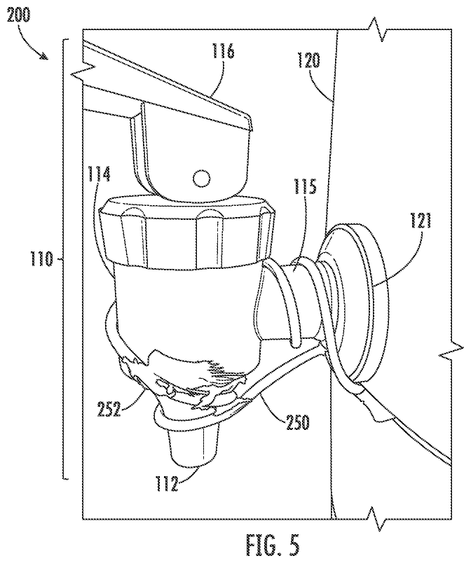

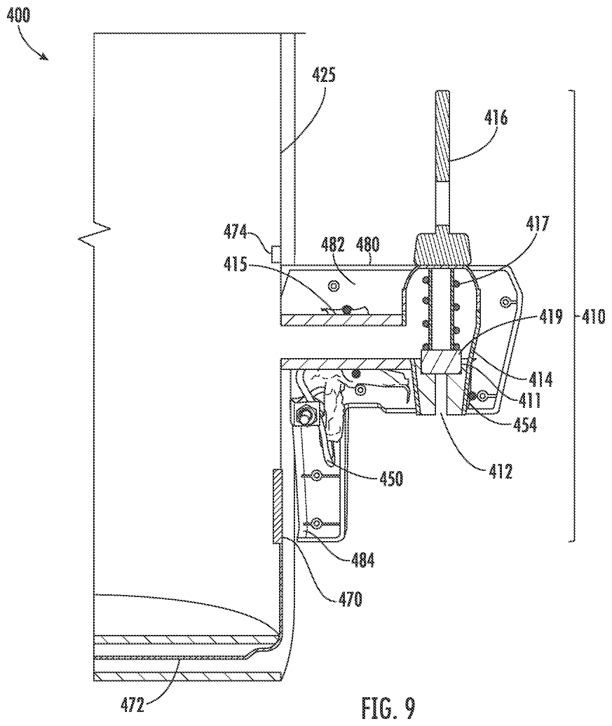

Any liquid paraffin 132 dripping from the spout 112 may remain in the melted state to prevent the paraffin in or around the spigot from cooling to room temperature and forming a solid paraffin blockage 130, which may prevent liquid paraffin 132 from flowing out from the tub 120 when the user pulls on the lever 116 of the spigot 110 the next time. Such a blockage 130 is prevented from forming because of heating element 250 (see FIG. 5) wrapped around the spigot 110. The heating element 250 may be externally affixed to the spigot 110 and may wrap around the spigot to heat portions of the spigot 110, to ensure that liquid paraffin 132 does not solidify when the lever 116 is moved to the closed position. An insulated cover 480 (see FIG. 9) may cover the heating element 250 as discussed below to prevent the heating element from burning the user. The heating element 250 may be disposed around strategic portions of the spigot 110, such as the pipe 115 that extends from the junction 121 where the spigot 110 and the tub 120 meet and the spout 112 from which liquid paraffin 132 may pour out of. In total, the heating element 250 may be wrapped around the spigot 110 between the junction 121 where the spigot 110 exits the tub 120 and the end of the spout 112, thereby ensuring that no portion of a liquid channel 125 (shown in FIG. 3) within the spigot 110 does not cool to a temperature that allows paraffin to solidify and possibly clog up the spigot 110—particularly the area about the spout 112.

Any suitable heating element may be used to heat the spigot 110, such as a silicone sheathed heating wire that heats up when a current is sent through the wire. As shown in FIG. 5, the heating element 250 may be attached to the spigot 110 using a heat-resistant adhesive 252, such as an acrylic or silicone glue or paste that hardens after being exposed to air. The heat-resistant adhesive 252 may be made from a material that does not melt or deform unless exposed to a temperature above a temperature that the heating element 250 is configured to reach. For example, the heat-resistant adhesive may comprise a material that only melts or deforms at temperatures above 400° F., 500° F., or even 600° F. The heating element 250 may also be configured to only heat to temperatures that may melt solid paraffin (e.g., 250° F.), and to not exceed temperatures that may melt such a heat-resistant adhesive (e.g., over 400° F.).

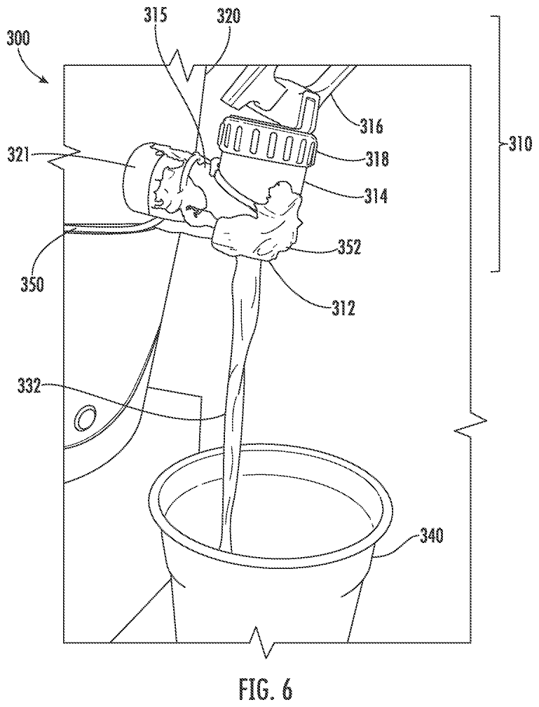

An alternative paraffin warmer system 300 is shown in FIG. 6. The paraffin warmer system 300 may have a tub 320, a spigot 310, and a heating element 350 attached to the spigot 310 to ensure that the liquid paraffin 332 does not solidify when the lever 316 is moved to the closed position. The paraffin warmer system 300 may have a flat spout 312 that is difficult to wrap the heating element 350 around. A heat-resistant adhesive 352 may be liberally applied to both affix the heating element 350 against the spigot 310, and to conduct heat from the heating element 350 to portions of the spigot 310 about the spout 312. The heat-resistant adhesive 352 may comprise a material having a high thermal conductivity, such as silicone or epoxy, which allows heat from the heating element 350 to conduct via the adhesive 352 to the perimeter of the spout 312. The heat-resistant adhesive may comprise a material having a thermal conductivity such as a material having a thermal conductivity of aluminum.

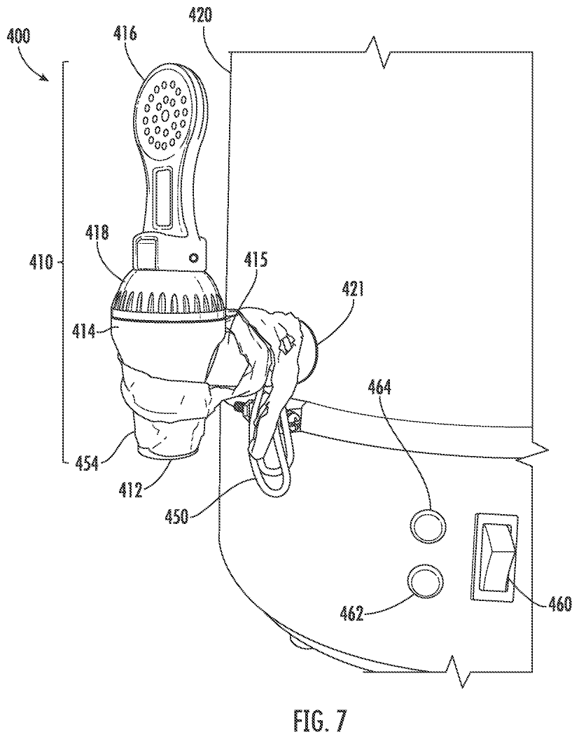

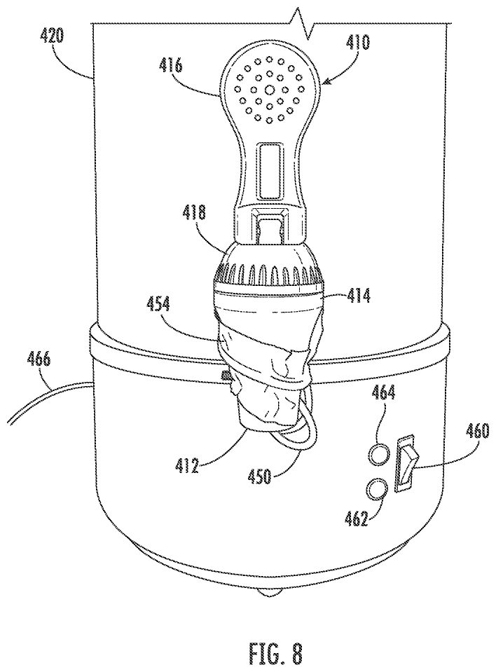

An alternative paraffin warmer system 400 is shown in FIGS. 7-10. The paraffin warmer system 400 may have a spigot 410 extending from a tub 420 with a heating element 450 attached to the spigot 410 via a heat-resistant tape 454. The heat-resistant tape 454 may comprise, for example, a high temperature aluminum tape configured to resist temperatures up to 600° F. and having a thermal conductivity of at least 0.7 W/(m*K). The heat-resistant tape 454 may be used to help affix the heating element 450 to the spigot 410 without melting when the heating element 450 is activated. Where the heat-resistant tape 454 comprises a material having a high thermal conductivity, such as aluminum, the heat-resistant tape 454 may help to transfer heat from the heating element 450 to parts of the surface of the spigot 410 to ensure that paraffin within and about the spigot 410 does not solidify.

A switch 460 may be used to activate the heating element 450. When the switch 460 is moved to the on position by a user, the heating element 450 may be activated to increase the temperature of the spigot 410. The heating element 450 may raise the temperature of the spigot 410 to be above the melting point of paraffin, which allows for liquid paraffin to be dispensed rapidly from the spigot 410 after activation. The tub 420 may also have a melting status light 464 and a keep warm status light 462, to inform a user of the status of the heating process. When the switch 460 is initially activated, the heating element 450 may be heated to a fast melt temperature, such as 300° F., which rapidly melts paraffin about the spigot 410. Since this fast melt temperature is well above the melting point for paraffin, the melting status light 464 may be activated to inform a user that the spigot 410 may be dangerous to directly touch. After a period of time (e.g. 15 minutes or 30 minutes) or after a sensor 474 (see FIG. 9) senses that the temperature within the cavity 425 is above a melting point of paraffin, the temperature of the heating element 450 may be adjusted to a lower keep warm temperature, such as 150° F., which ensures that paraffin about the spigot 410 does not solidify. A control board, such as the control board 470 shown in FIG. 9, may be used to control the temperature of the heating element 450. The control board 470 may also be used to control a heating element 472 disposed along the bottom of the tub cavity 425, allowing for the paraffin warmer system 400 to increase the temperature of different portions of the apparatus via one temperature control board.

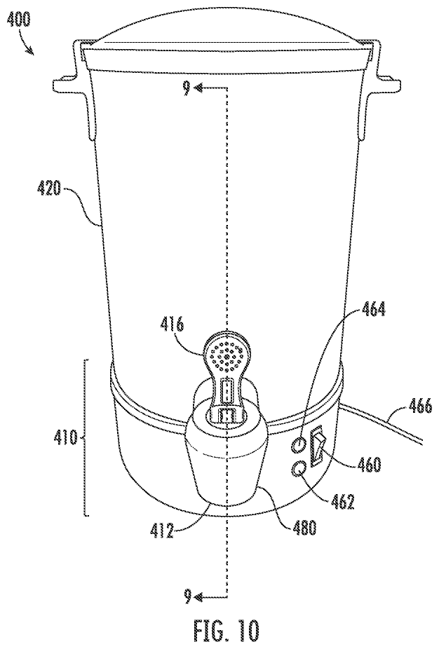

As shown in FIGS. 9-10, an insulating cover 480 may be placed around a portion of the spigot 410 to prevent a user from being burnt by the warm spigot 410 or the heating element 450 during use. The insulating cover 480 may be configured to cover both the heating element 450 and the adhesive 454 used to affix the heating element 450 to the spigot 410. The insulating cover 480 may also comprise one or more air pockets 482 between the surface of the spigot and the surface of the insulating cover 480, which may help to prevent ambient heat from reaching the surface of the insulating cover 480. The insulating cover 480 may comprise any material having a low thermal conductivity, such as a plastic having a thermal conductivity of at most 0.05 or 0.03.

Various paraffin warmer systems and methods are explained in more detail below.

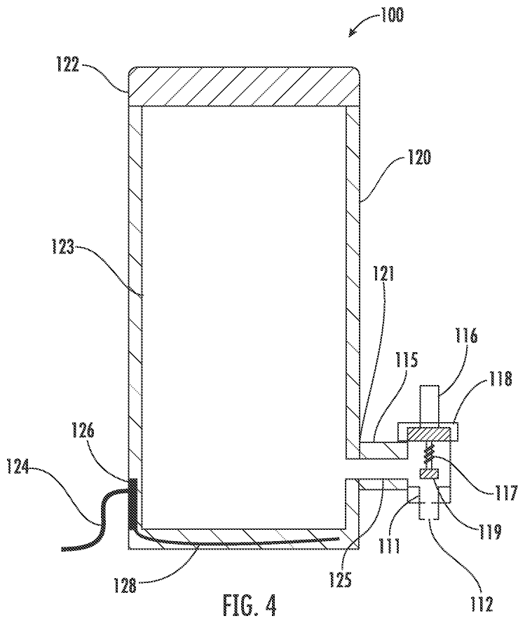

In FIGS. 1, 2, 3 and 4, a paraffin warmer system 100 may have a tub 120 configured to hold a volume of paraffin wax, for example at least 5, 10, 15, or 20 lbs. of paraffin. The tub may be shaped in any suitable means, such as a rectangular prism shape, or the upright cylindrical shape shown in FIGS. 1, 2, 3 and 4. Seen more clearly in the cross-sectional view of FIG. 4, the tub 120 may have a cavity 123 configured to heat paraffin within the cavity 123 to at least a melting point of paraffin, for example to a temperature of at least 120° F., 150° F., 180° F., 200° F., or 230° F.

Any suitable means of heating paraffin within the tub 120 may be used. For example, the tub 120 may have a heating element 128 configured to heat a portion of the cavity 123 to a desired temperature when the power cord 124 is plugged in to a power source, such as a wall outlet. The heating element 128 may comprise any suitable device configured to emit heat when power is transmitted to the device. For example, the heating element 128 may have a simple wire or coil having a high resistance, which emits heat without melting when power is transmitted through the wire. Alternatively, the heating element 128 may have a thick film heater printed on a surface of the cavity 123 that may be configured to heat when an electric current is passed through the film, heater pad and/or heater rod. A temperature control board 126 may be electronically connected to both the power cord 124 and the heating element 128, and may be programmed to transmit a current through the heating element 128 and increase the temperature within the cavity 123 of the tub 120 to liquefy paraffin located within the cavity.

Paraffin may be placed in the cavity 123 by removing the top 122 from the tub 120 and by disposing paraffin into the cavity 123. For example, a user may pour liquid paraffin into the cavity 123, may pour solid paraffin beads into the cavity 123, or may place solid paraffin blocks into the cavity 123. When the heating element 128 is activated, the heating element 128 may emanate heat to raise an internal temperature of portions of the cavity 123 to be above a melting point of paraffin. Any solid paraffin placed in the cavity 123 may be melted by the heat to become liquid. Liquified paraffin in the cavity 123 may flow through the liquid channel 125 of the pipe 115 and out of the spout 112 of the spigot 110 when the lever 116 is moved to the open position shown in FIG. 2. The spigot 110 may be located in close proximity to the bottom of the tub 120 (e.g. less than ½ inch or 1 inch from the floor of the cavity 123) to ensure that melted liquid paraffin from the cavity 123 may be rapidly dispensed via the spigot 110.

The spigot 110, shown in FIG. 2, may have a top portion 118 and a bottom portion 114. The top portion 118, shown more clearly in FIG. 3, may have a valve used to open and close the spigot 110. For example, the stopper 119 may be configured to fit within the cavity 111 of the bottom portion 114 and form a liquid-tight seal to prevent liquid from flowing from the cavity 123 of the tub 120 out of the spout 112. The stopper 119 may comprise an elastic material, such as a rubber or flexible plastic, to help maintain the liquid-tight seal when the spring 117 presses down on the stopper 119. A lever 116 may be used to move the flexible stopper 119 between a closed position, shown in FIG. 1, and an open position, shown in FIG. 2. A spring 117 may be used to bias the lever 116 towards the closed position, to help ensure that the default position for the flexible stopper 119 is to rest within the cavity 111 to form a liquid-tight seal. While a spring-powered plug valve is shown to open and close a fluid pathway between the cavity 111 of the tub 120 and the spout 112 of the spigot 110, any suitable valve may be used, such as a ball valve, butterfly valve, check valve, gate valve, or a pinch valve.

When the lever 116 is in the open position, as shown in FIG. 2, liquid paraffin 132 may freely flow out the spout 112 into the container 140. When the lever 116 is in the closed position, as shown in FIG. 1, liquid paraffin 132 no longer flows out the spout 112 into the container 140. Since the exterior surface of the spout 112 may be at a lower temperature than the interior cavity 123 of the tub 120, residual liquid paraffin dripping from the spout 112 may solidify to form a solid paraffin blockage 130 after the lever 116 is moved from the open position shown in FIG. 2 to the closed position shown in FIG. 1. The solid paraffin blockage 130 may prevent liquid paraffin 132 from cleanly flowing out of the spout 112 when the lever 116 is moved to the open position in FIG. 2, which could cause the liquid paraffin 132 to spray to the side or could otherwise disrupt flow of the liquid paraffin 132 into the container 140. Moreover, the solid paraffin blockage 130 may be exposed to the air or other contaminants, and may then drop into the container 140 when the lever 116 is moved to the open position in FIG. 2, thereby polluting liquid paraffin 132 flowing out of the tub 120 and into the container 140.

An improved paraffin warmer system 200 is shown in FIG. 5, may comprise a heating element 250 wrapped around the spigot 110. The heating element 250 may comprise any suitable device that heats up when a current is passed through it, such as a wire having a high resistance. The heating element 250 may be flexible enough to be easily wrapped around the spigot 110 by hand but may be stiff enough to retain its shape about the spigot 110 after being wrapped around the spigot 110. The heating element 250 may comprise a material that does not melt or deform at normal operating temperatures, for example between 0° F. and 400° F. A silicone sheathed heating wire may be used as a heating element, as the silicone may ensure that the wire retains its shape after wrapping around the spigot. The heating element 250 may be configured to heat the liquid channel 125 (shown in FIG. 4) between the tub 120 and the spout of the spigot 112 to ensure that any paraffin that may have solidified within the channel is swiftly melted by the heating element 250 when it is activated. The externally affixed heating element 250 shown in FIG. 5 may be configured to wrap around the spigot from the junction 121 where the spigot 110 meets the tub 120 to the spigot's distal end at the spout 112 to ensure that the entire liquid channel 125 (shown in FIG. 4) is heated by the heating element 250.

While the heating element 250 may comprise a material that retains its shape after wrapping around the spigot 110, the heating element 250 may be further affixed in place to the spigot 110 using a temperature-resistant adhesive 252, such as an acrylic, silicone, or epoxy paste that hardens after being exposed to air. Such adhesives may comprise a material having a melting point higher than the operating temperatures of the heating element 250, such as at least 400° F., 500° F., or even 600° F. Such adhesives may also comprise a material having a high thermal conductivity, such as a thermal conductivity of at least 0.3, 0.4, 0.5, 0.6, 0.7, or 0.8 W/(m*K). Using adhesives with a high thermal conductivity may help to transmit heat from the heating element 250 to portions of the spigot 110 via the temperature-resistant adhesive 252. While the temperature-resistant adhesive 252 is shown in FIG. 5 as a glue-type adhesive, any suitable temperature-resistant mechanism may be used to help fasten the heating element 250 in place about the spigot 110, for example a high-temperature aluminum tape or a metal clamp may be used instead of a glue-type adhesive.

The heating element 250 may be electronically connected to the same temperature control board 126 that is used to heat the heating element 128 in the tub 120. By functionally coupling the heating element 250 to the same temperature control board 126, the heating element 250 may be configured to heat the spigot 110 as soon as the paraffin warmer system 200 is turned on (e.g., plugged in, or a switch connected to the temperature control board 126 is flipped). Since the spigot 110 may be in close proximity to both the heating element 250 and the bottom of the cavity 123, melted liquid paraffin may be dispensed rapidly from the spigot 110 after the paraffin warmer system 200 is activated. Such a paraffin warmer system 200 may be used to dispense liquid paraffin within 15 minutes of turning the unit on, even if paraffin near the top of the cavity 123 may still be solid. Since the liquid channel (i.e., from the junction 121 through the pipe 115 to the spout 112) spigot 110 may be heated by the heating element 250, any residual liquid paraffin disposed within and about the liquid channel 125 after the lever 116 is moved to the closed position, particularly and liquid paraffin disposed about the spout 112, won't solidify since the surface of the spigot 110 remains above the melting point of paraffin so long as the heating element 250 is activated.

The bottom portion 114 of the spigot 110 may comprise any suitable material that allows heat from the heating element 250 to heat up paraffin located within the spigot 110, such as a heat-conducting metal. Using a material with a high thermal conductivity may help to transfer heat from the heating element 250 to the interior of the liquid channel 125 to prevent blockages, such as the solid paraffin blockage 130 shown in FIG. 1, from forming even when using the paraffin warmer system 100 of FIG. 1 without the heating element 250. Such a heat-conducting metal may easily conduct heat from the cavity 123 of the tub 120 to the spout 112 of the spigot 110. Alternatively, a heat-conducting plastic may be used to manufacture the bottom portion 114 of the spigot 110 to prevent possible electrical shock to a user from the heating element 250 wrapped around the spigot 110 in FIG. 5. The bottom portion 114 of the spigot 110 may be made from a polyamide nylon plastic that does not melt or deform when exposed to temperatures below 392° F. The external heating element 250 may be configured to not exceed a temperature that may deform or melt the spigot 110 (e.g., 392° F. for polyamide nylon plastic). The top portion 118 of the spigot 110 may be affixed to the bottom portion 114 of the spigot 110 using any suitable means, for example by screwing a threaded cover 113a of the top portion 118 to a threaded edge 113b of the bottom portion 114.

An alternative paraffin warmer system 300 shown in FIG. 6 may be used, comprising a spigot 310 comprising both a top portion 318 and a bottom portion 314 made from a polyamide nylon plastic that does not melt or deform when exposed to temperatures below 392° F. and a thermal conductivity of 0.3. The spigot 310 may extend from the tub 320 from junction 321, which may allow liquid paraffin 332 to flow from the tub 320 through the pipe 315 out the spout 312 and into the container 340. The heating element 350 may be wrapped around the pipe 315 and the body of the spigot 310 about the spout 312 to ensure that a liquid channel from the junction 321 to the spout 312 is heated by the heating element 350.

A heat-resistant adhesive 352 having a thermal conductivity above 0.2 or 0.3 may be used to affix the heating element 350 to the spigot 110. The heat-resistant adhesive 352 may be spread about the surface of the spigot 110, particularly around the spout 112 of the spigot 110, to ensure that liquid paraffin does not solidify about the spigot 110 when the lever 316 is moved to a closed position. The heat-resistant adhesive may be spread about any portion of the spigot 110 to help conduct heat from the heating element 250 to portions of the spigot 110 to distribute heat to the paraffin liquid channel.

An alternative paraffin warmer system 400 is shown in FIGS. 7-10, which may comprise a spigot 410 extending from a tub 420, with a spigot warmer heating element 450 that may be wrapped around portions of the bottom portion 414 of the spigot 410, such as the pipe 415 and the area surrounding the spout 412. The heating element 450 may wrap around the spigot from the junction 421 between the spigot 410 and the tub 420 and the spout 412. The heating element 450 may be affixed to the spigot 410 using a heat-resistant adhesive tape 454. The heat-resistant adhesive tape 454 may comprise a high temperature aluminum tape that may act as an adhesive to ensure the heating element 450 stays in place about the spigot 410, may be resistant to melting or deforming at high temperatures, such as at least 600° F., and may have a thermal conductivity of at least 1 or 2 W/(m*K) to help transmit heat from the heating element 450 to portions of the spigot 410. The spigot 410 may comprise a polyamide nylon plastic that does not deform or melt at temperatures below 392° F., ensuring that the spigot 410 does not deform or melt when the heating element 450 is activated to either a melting temperature or a keep warm temperature.

As shown in FIGS. 9-10, an insulating cover 480 may be disposed around a portion of the spigot 410 to prevent a user from being burnt by portions of the spigot 410, such as the outer surface of the pipe 415 or the heating element 450. FIG. 9 shows a cross-sectional view taken at the dotted-line 9 shown in FIG. 10. The insulating cover 480 may be configured to cover both the heating element 450 and the adhesive 454 used to affix the heating element 450 to the spigot 410. The insulating cover 480 may also comprise one or more air pockets 482 between the exterior surface of the spigot and the exterior surface of the insulating cover 480. Warm air within the air pockets 482 may circulate out of one or more air vents 484 about the insulating cover 480, which may allow air in the air pockets 482 to cool as ambient air circulates in and out of the insulating cover 480. While only a single air vent 484 is shown, multiple air vents may be formed in a surface of the insulating cover 480 to help allow ambient air to circulate within the insulating cover 480.

The insulating cover 480 may comprise a material having an R-value of at most 1 m²*K/W, such as a polyurethane or a polyethylene. The insulating cover 480 may comprise the same material as the pipe 415 and the bottom portion 414 of the spigot 410 or may comprise a different material. For example, both the insulating cover 480 and the pipe 415 may comprise a polyamide nylon plastic having a similar thermal conductivity, or the insulating cover 480 may comprise an ethylvinylacetate or a phenolic plastic that may have a lower thermal conductivity (e.g., 0.8 and 0.17 W/(m*K)) than a polyamide nylon plastic (e.g., 0.28 W/(m*K)) composing the pipe 415.

The switch 460 may be electronically coupled to a temperature control board 470, which may be configured to activate the heating element 472 disposed in the floor of the cavity 425 of the tub 420, and may be configured to activate the heating element 450 affixed to the exterior surface of the spigot 410. The temperature control board 470 may be configured to heat the heating element 450 to a same temperature, or a different temperature, than the heating element 472. For example, the temperature control board 470 may be configured to heat the heating element 450 to a first temperature for a first period of time while heating the heating element 472 to a second temperature for a second period of time. The first temperature may be higher than the second temperature, the same as the second temperature, or lower than the second temperature, and the first time period may be lower than the second time period, the same as the second time period, or higher than the second time period. The temperature control board 470 may also be configured to raise or lower the temperature of the heating elements 472 and 450 after a period of time. For example, after a user activates the switch 460, the temperature control board 470 may be configured to heat the heating elements 472 and 450 to a melting temperature for a period of time (e.g., 300° F. for 15 minutes), and then may adjust the heat of the heating elements 472 and 450 to a keep warm temperature until the switch 460 is turned off (e.g., 150° F.). The temperature control board 470 may also be configured to activate corresponding warning lights to indicate to a user the temperature that it is maintaining. For example, the temperature control board 470 may be configured to activate a red melting status light 464 when the temperature control board is heating either of the heating elements 472 or 450 to a melting temperature, and maybe configured to activate a green keep warm status light 462 when the temperature control board 470 is heating both of the heating elements 472 and 450 to a keep warm temperature.

A sensor 474 may be used to monitor a temperature of a portion of the cavity 425 of the tub 420, for example by detecting a temperature using a resistance temperature detector (RTD). The sensor 474 may be configured to measure any suitable portion of the cavity 425, such as a temperature of a portion of the wall of the cavity 425, a temperature of wax disposed within the cavity 425, or even the heating element 472 or heating element 450. The temperature control board 470 may be configured to heat one or both of the heating elements 472 and 450 to a melting temperature, and then may reduce the temperature of the heating element(s) to a keep warm temperature when the temperature control board 470 receives a signal from the sensor 474 that a threshold temperature has been reached. The sensor 474 may be disposed within at most 5, 10, or 15 cm. from the opening of the pipe 415, to ensure that liquid paraffin may freely flow from the cavity 425 of the tub 420 through the pipe 415 of the spigot 410. The sensor 474 may also be configured to detect whether paraffin is present in the tub 425 using any suitable means, for example by detecting a weight of paraffin pressing against the sensor 474 using a piezoelectric sensor. The temperature control board 470 may be configured to deactivate heating of the heating elements 472 and 450 when it receives a signal from the sensor 474 that the pressure against a piezoelectric sensor has dropped below a threshold.

The spigot 410 may comprise a top portion 418 that acts as a plug valve triggered by movement of the lever 416—similar to the top portion 118 of FIG. 3. A cross-sectional area of the spigot 410 may be seen in FIG. 9, which shows a lever 416, a spring 417, and a plug 419. The plug 419 may be sized and disposed to fit within the cavity 411 and plug up the spout 412, thereby preventing liquid paraffin from the cavity of the tub 425 from flowing out the spout 412 via the pipe 415. The spring 417 may be biased to push down on the plug 419 and keep the spout 412 closed when no force is being applied to the lever 416. When a user pulls the lever 416, the plug 419 may be raised to allow liquid paraffin to flow from the cavity of the tub 425 out the spout 412 via the pipe 415. When a user releases the lever 416, the spring 417 may then push down on the plug 419 to enter the cavity 411 and form a liquid-tight seal, thereby preventing liquid paraffin from continuing to exit the spout 412.

The heating element 450 and the heat-resistant adhesive tape 454 may heat portions of the fluid passageway between the cavity 425 of the tub 420 and the spout 412, such that after the lever 416 is released, residual liquid paraffin about the spigot 410 does not solidify—particularly about the spout 412. The cavity 425 of the tub 420 may be configured to hold any suitable amount of paraffin, such as at least 5, 10, 15, or 20 lbs. of paraffin.

While the paraffin warmer system 400 is shown in FIGS. 9-10 as having a tub 420 with a single cavity 425 and a single spigot 410, such tubs may be configured to have a plurality of cavities, each with its own spigot and heating element. Such embodiments may comprise, for example, a tub that is internally divided into two or more cavities (e.g., by disposing a liquid-tight divider within a single cavity), each of which has a separate liquid channel to a spigot heated by a heating element. Such tubs may have different kinds of paraffin wax disposed in each cavity. For example, a first scented and colored paraffin wax may be disposed in a first cavity of a tub, while a second scented and colored paraffin wax may be disposed in a second cavity of a tub. Such tubs may be used to dispense either paraffin wax rapidly from either heated spigot.

The heating of each spigot may be configured in any suitable manner. For example, both of the heating elements may be controlled by a single temperature control board that heats each heating element to the same temperature in accordance with the methods described above. Alternatively, each of the heating elements may be controlled by a separate temperature control board, each of which receives input from different sensors disposed about the different cavities. For example, a sensor in a first cavity may be configured to send signals to a temperature control board controlling a heating element wrapped around a spigot that dispenses of paraffin wax from the first cavity, while a sensor in a second cavity may be configured to send signals to a temperature control board controlling a heating element wrapped about a spigot that dispenses of paraffin wax from the second cavity. A single control board may also be configured to receive input from sensors of discrete cavities and to transmit different output signals to discrete heating elements. Such configurations may be useful, for example, where one cavity has run out of paraffin wax while another cavity still holds paraffin wax, or when each cavity holds paraffin wax having different melting points.

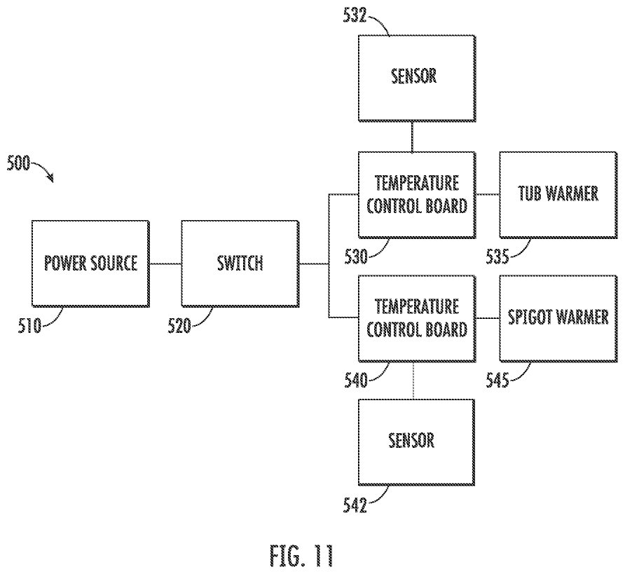

A logical diagram 500 of a contemplated circuit for a paraffin warming system, such as the paraffin warming system 300 in FIG. 6, or the paraffin warming system 400 shown in FIGS. 6-9, is shown in FIG. 11, having a power source 510, a switch 520, and two temperature control boards 530 and 540 controlling the temperature for two heating elements, a tub warmer heating element 535 and a spigot warmer heating element 545. The power source 510 may comprise any power source suitable to power one or more temperature control boards and one or more heating elements. For example, the power cable 466 in FIG. 10 may be plugged into a wall outlet (not shown) to provide power to the power source 510. The switch 520 may be used to control activation of the temperature control boards 530 and 540, which each control the temperature of the tub warmer heating element 535 and the spigot warmer heating element 545.

When the switch 520 is activated, such as by a user flipping the switch 460 in FIG. 10, each of the temperature control boards 530 and 540 may be configured to control the temperatures of the tub warmer heating element 535 and the spigot warmer heating element 545. For example, when activated by the switch 520, the temperature control board 530 may be configured to heat the tub warmer heating element 535 to 300° F. for 15 minutes, and then to 180° F. until the switch 520 is deactivated. Similarly, when activated by the switch 520, the temperature control board 540 may be configured to heat the spigot warmer heating element 545 to 250° F. for 15 minutes, and then to 180° F. until the switch 520 is deactivated.

While two separate temperature control boards 530 and 540 are shown here to control the heat of two separate heating elements (tub warmer heating element 535 and spigot warmer heating element 545, respectively), a single temperature control board may be used to control two separate heating elements—such as the single temperature control board 470 that is configured to control the tub warmer heating element 472 and the spigot warmer heating element 450.

The temperature control boards 530 and 540 may also be functionally coupled to sensors 532 and 542, which may function similarly to sensor 474 shown in FIG. 9. For example, sensor 532 may comprise a temperature sensor that is disposed about a tub, such as an interior of a spigot or a wall of a cavity of tub, to ensure that a desired temperature is reached. The temperature control board 530 may then increase power sent to the tub warmer 535, or may start transmitting power to the tub warmer 535, when the temperature drops below a lower threshold temperature, and may decrease power sent to the tub warmer 535, or may stop transmitting power to the tub warmer 535, when the temperature increases above a threshold temperature. Alternatively or additionally, the sensor 542 may comprise a pressure sensor that detects a presence of a material within a portion of a tub, such 2 inches above the bottom of the tub, or within the spigot of a tub. The temperature control board 530 may then shut off if the sensor 542 sends a signal that it does not detect the presence of a material within that portion of the tub. Likewise, sensor 542 may comprise a similar temperature sensor or a similar pressure sensor, that is similarly configured to transmit signals to the temperature control board 540, which may be programmed to respond similarly.

The above description is given by way of example, and not limitation. Given the above disclosure, one skilled in the art could devise variations that are within the scope and spirit of the invention disclosed herein. Further, the various features of the embodiments disclosed herein may be used alone, or in varying combinations with each other and are not intended to be limited to the specific combination described herein. Thus, the scope of the claims is not to be limited by the illustrated embodiments.

What is claimed is:

1. A paraffin warmer, comprising:
a tub for holding paraffin;
a spigot for dispensing paraffin from the tub, the spigot attached to a lower portion of the tub; and
a first heating element attached to the spigot, the first heating element heating a liquid channel of the spigot to at least a paraffin melting point.

2. The paraffin warmer of claim 1, wherein the first heating element is a silicone sheathed heating wire.

3. The paraffin warmer of claim 2, wherein the wire is wrapped around an external surface of the spigot to heat the liquid channel of the spigot.

4. The paraffin warmer of claim 3, further comprising an insulating cover that encapsulates at least a portion of the wire wrapped around the spigot, wherein the insulating cover is a thermal insulator.

5. The paraffin warmer of claim 4, wherein the insulating cover comprises a polyamide nylon plastic.

6. The paraffin warmer of claim 1, further comprising an aluminum tape that is attached the first heating element and the spigot to conduct heat from the first heating element to the spigot to locations where the wire cannot be wrapped around the spigot.

7. The paraffin warmer of claim 1, further comprising a temperature control board that heats the spigot warmer to at least the paraffin melting point.

8. The paraffin warmer of claim 4, wherein the temperature control board is configured to heat the first heating element to a fast melt temperature above a melting temperature of the paraffin, and wherein the temperature control board is configured to lower a temperature of the first heating element to a keep warm temperature.

9. The paraffin warmer of claim 1, further comprising a second heating element attached to the tub that heats a cavity of the tub to at least the paraffin melting point.

10. The paraffin warmer of claim 9 wherein the first heating element is settable to a temperature different from the second heating element.

11. The paraffin warmer of claim 1, wherein the spigot comprises a polyamide nylon plastic.

12. A method of dispensing paraffin into a container, comprising:
disposing solid paraffin into a tub of a paraffin warmer;
heating a spigot and a tub of the paraffin warmer to at least a melting point of the paraffin to melt paraffin in the liquid channel;
disposing the container below a spout of the spigot; and
opening a valve between a cavity of the tub and the liquid channel to allow melted paraffin to travel through the heated liquid channel out the spout of the spigot into the container.

13. The method of claim 12, further comprising maintaining a temperature of the liquid channel to be above the paraffin melting point for at least 10 minutes prior to opening the valve.

14. The method of claim 12, wherein heating the liquid channel of the spigot comprises externally affixing a heating element around the liquid channel between a junction between the tub and the spigot and the spout of the spigot.

15. The method of claim 14, wherein externally affixing the heating element comprises applying a high temperature aluminum tape to the heating element and the spigot.

16. The method of claim 12, further comprising heating the liquid channel of the spigot while also heating the volume of paraffin within the tub.

17. The method of claim 12, further comprising covering at least a portion of the spigot with a plastic cover to protect a user from getting burned by the spigot.
